(19) United States
(12) Patent Application Publication
(10) Pub. No.: US 2023/0418730 A1
(43) Pub. Date: Dec. 28, 2023

(54) TEST CASE GENERATOR USING AUTOMATION LIBRARY OF AN INFORMATION HANDLING SYSTEM

(71) Applicant: Dell Products L.P., Round Rock, TX (US)

(72) Inventors: Suren Kumar, Bangalore (IN); Thanuja C, Bangalore (IN)

(73) Assignee: Dell Products L.P., Round Rock, TX (US)

(21) Appl. No.: 17/808,204

(22) Filed: Jun. 22, 2022

(51) Int. Cl. G06F 11/36

(52) U.S. Cl. CPC G06F 11/3684

(57) ABSTRACT

Code files for performing test cases on information handling systems may be generated from pre-existing test cases using natural language processing and/or machine learning algorithms. For example, a method may include receiving a test case comprising a plurality of tasks; identifying, by inputting the test case into a machine learning algorithm, a subset of code segments from code segments of at least one pre-existing test case in a code library matching at least one task of the plurality of tasks in the test case; and generating an indication of the subset of code segments for re-use from the at least one pre-existing test case for the test case.

### FIELD OF THE DISCLOSURE

The instant disclosure relates to information handling systems. More specifically, portions of this disclosure relate to a method to analyze a test case using a machine learning algorithm to generate a report of the subset of code segments.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When there is a new test case to be automated, an automation team, for example, must analyze and identify the segments of code which are to be newly written or which can be modified or reused from a pre-existing library. This presents the challenge of finding a single or combination of modules or code segments from pre-existing test cases without a thorough and comprehensive knowledge of the code library.

Shortcomings mentioned here are only representative and are included to highlight problems that the inventors have identified with respect to existing information handling systems and sought to improve upon. Aspects of the information handling systems described below may address some or all of the shortcomings as well as others known in the art. Aspects of the improved information handling systems described below may present other benefits than, and be used in other applications than, those described above.

### SUMMARY

An information handling system with a storage of pre-existing test cases residing in a code library may analyze, using a machine learning algorithm, an input test case. The machine learning algorithm may identify code segments from the pre-existing test cases in the code library based on the input test case to assist the test automation engineer in preparing a code file for executing the input test case by identifying re-usable code. The re-usable code may include code that may be re-used for the input test case with no modification and/or code that may be re-used for the input test case with modification. In some embodiments, the information handling system may generate a report based on the input test case and identification of code segments. The report informs the test automation engineer, for example, of the percentage of code which needs to be newly developed, the percentage of code to be modified from on the pre-existing code segments, and/or the percentage of code which may be re-used from the pre-existing code segments. The information handling system may output this report to the user along with the code segments referenced by the report for their modification or reuse. In some embodiments, a code file may be generated that includes the identified re-usable code and/or blank sections corresponding to sections to be written by the test automation engineer because there is no match in the code library. In some embodiments, portions of the re-usable code may be modified based on the input test case and then included in the code file.

According to one embodiment, an information handling system receives a test case and code segments from pre-existing test cases in a code library. The system may identify a subset of code segments in the code library that are based on the test case by inputting the test case and code segments into a machine learning algorithm, which may be executed by the information handling system and/or a different information handling system (such as a cloud computing system). Finally, the information handling system may generate a report of the subset of code segments.

In certain embodiments, the machine learning algorithm corresponds to a large-margin approach for multi-label classification based on correlation between labels. Multi-label classification is a task within machine learning which assigns a sample to a subset of available label sets, meaning a sample can belong to multiple labels. One example is classifier-chains, which is a method for multi-label classification based on binary relevance. Large-margin classification maximizes the distance between the data points and the decision boundary, therefore maximizing the margins. This can be implemented by a variety of learning algorithms, such as a support vector machine. In embodiments of this disclosure, a large-margin approach for multi-label classification may be applied for comparing tags corresponding to tasks in an input test case to tags corresponding to pre-existing test cases in a code library.

The machine learning algorithm analyzes the code library to generate a report, in which the code library comprises pre-existing test cases divided into code segments by the information handling system using an analytics engine. The machine learning algorithm generates transporter multi-label vectors using the multi-label learning models which identify for re-use code segments that match an input test case. The machine learning algorithm analyzes the input test case and identifies portions of the input test case that are in need of development, and if the test case steps can be automated or require manual intervention, such as hot-pluggable steps for any hardware, necessary addition or removal of hardware, etc. The machine learning algorithm may also create an automated test case script as a code file using code segments from at least one test case.

In certain embodiments, the identification of code segments may use topic modeling and store tags with the code segments in the code library. The code segments may be analyzed by a code segment identification tagger which tags each code segment with a classifier relevant to the test case steps and comments within the code segment. The code segments may be analyzed and identified by one or more of topic modeling, topic classification, and/or text-mining techniques, including, for example, latent Dirichlet allocation (LDA). LDA uses text vectorization to transform the code segments into data that a machine learning model can compare with similar text vectorization data of an input test case. Each test case comprises a plurality of code segments which are individually identifiable by the machine learning algorithm. In certain embodiments, code segments that are commonly used may be marked as a frequently-used within the code library by an identifier, which is used to identify likely relevant code segments from the library for an input test case.

In certain embodiments, the training data and expected outputs are input to a machine learning algorithm to train a model to make association between a particular input and its corresponding output. The machine learning model may be trained to classify one or more tasks of an input test case based on analysis of the input test case requirements and/or readable comments that are written in the input test case. The machine learning algorithm may apply LDA to generate tags corresponding to the tasks in the input test case and identify relevant code segments from the code library based on matching tags between a tag for a task of the input test case and a tag for a code segment from the code library.

In some embodiments, the code library may be known as an automation library, in which the automated test cases are stored for external or internal team usage. The automation library may act as a common library for the automation engineers as well as other internal and/or external users, a centralized library for external users only, an internal library with limited access, an online database or library, a library within the memory of the information handling system, or any other method of storage with varying levels of accessibility. The test case to be used as input to the machine learning algorithm comprises test steps with a description for each requirement of the test case. Example tasks include, but are not limited to, entering the BIOS setup utility and updating the BIOS to a newer version.

According to another embodiment, a method may include generating a report using the machine learning algorithm, which may include a categorized automation execution plan comprising three percentages: (1) a first percentage of code for the input test case that requires new automation development; (2) a second percentage of code for the input test case that requires modification to an existing code segment from the code library; (3) a third percentage of code for the input test case that may re-use available code segments from the code library. This report, which may also be known as a testcase analysis report, is generated for an input test case. In certain embodiments, the code segments that are newly developed by the test automation engineer may be added to the code library for future re-use.

In some embodiments, the method may further include the machine learning algorithm outputting a tailored automated test case script which is created by combining code segments from at least one pre-existing test case from the code library. The machine learning algorithm may also generate a code file based on the analysis which already contains the reusable code recommended for the new test case requirement. In another embodiment, this code file may also include the code which the machine learning algorithm recommends the user modify. The code may also be presented in a structured code design, with or without comments, or any other variation of organizing the output to communicate the code segments which are reusable, require modification, or require new development to the user. As for the output of the machine learning algorithm, it may output a single code segment per requirement per code file, a compiled code file with the code segments aligned with the input test case requirements, or any other variation of such. Further, the machine learning algorithm may output the code segments which require modification by the user in a separate code file from the code segments which were determined to be reusable.

The methods described herein may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating inputs and outputs for analyzing an input test case by an information handling system according to some embodiments of the disclosure.

FIG. 2 illustrates a block diagram for topic modelling of code segments in a code library of automation test cases according to some embodiments of the disclosure.

FIG. 3A is a block diagram illustrating generation of a code library for pre-existing test cases according to some embodiments of the disclosure.

FIG. 3B is a block diagram illustrating use of a code library in generating a code file corresponding to an input test case according to some embodiments of the disclosure.

FIG. 4 is a flow chart illustrating a method for processing an input test case according to some embodiments of the disclosure.

FIG. 5 is a flow chart illustrating outputs based on processing of an input test case according to some embodiments of the disclosure.

FIG. 6 is a schematic block diagram of an example information handling system according to some embodiments of the disclosure.

### DETAILED DESCRIPTION

An information handling system with access to a code library of pre-existing test cases may generate a report based on an input test case to identify re-usable code segments. A machine learning algorithm may identify code segments from the code library based on the input test case and organize matching code segments for re-use into a report. The report informs an automation test engineer, for example, of the percentage of code which needs to be newly developed, the percentage of code to be modified based on the pre-existing code segments, and the percentage of code which may be reused from the pre-existing code segments.

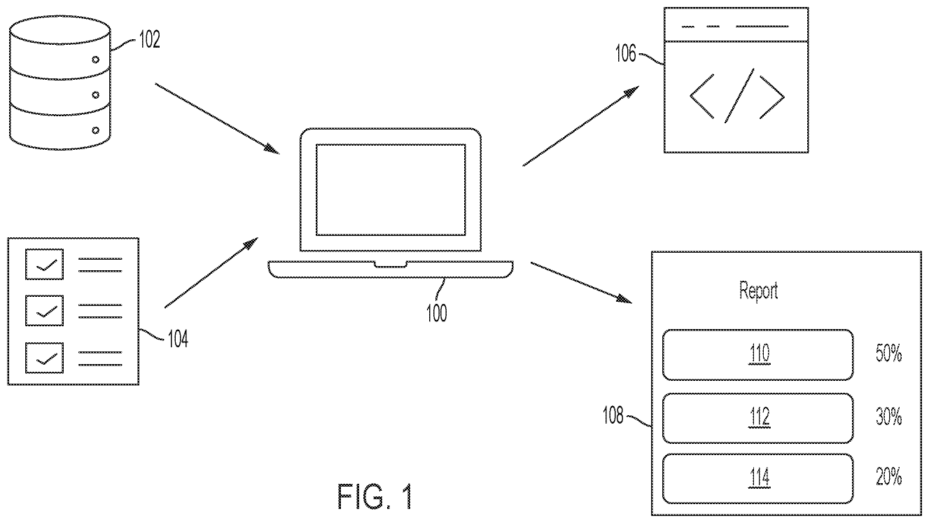

These example embodiments describe and illustrate various techniques for processing an input test case using an information handling system. FIG. 1 is a block diagram illustrating inputs and outputs for analyzing an input test case by an information handling system according to some embodiments of the disclosure. Information handling system 100 executes a machine learning algorithm that receives input test case 104 and retrieves code segments from the code library 102 for comparison to the input test case 104. In some embodiments, the code library 102 may be remote from the information handling system 100, such as accessible through a network connection. In some embodiments, the input test case 104 may be received from a remote information handling system 100, such as when a user accesses a web interface to the information handling system 100 to provide the input test case 104. The machine learning algorithm executing on information handling system 100 may output a code file 106 with code segments based on matches determined by the algorithm between the input test case 104 and code segments in the code library 102. The code file 106 may be presented in any format or filetype, and may include comments, headers, color distinction, or any other presentation to present a pre-started test case. The machine learning algorithm may also or alternatively output a report 108, which may include an execution plan for the user, and contains a first percentage 110 of code from the pre-existing code library which is reusable, a second percentage 112 of code from the pre-existing code library which requires modification, and a third percentage 114 of code which requires new development.

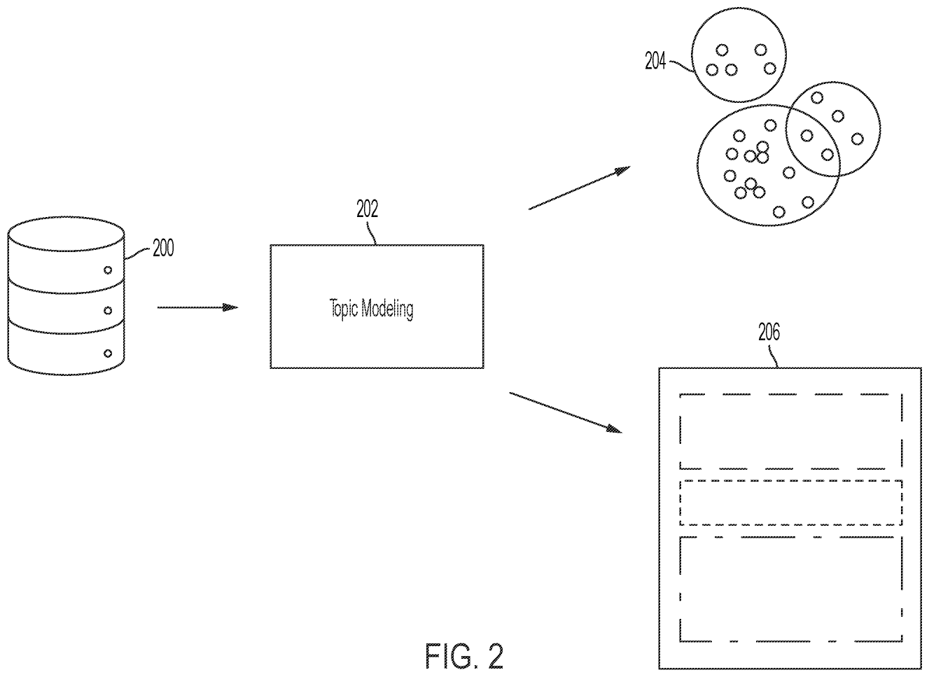

FIG. 2 illustrates a block diagram for topic modelling of code segments in a code library of automation test cases according to some embodiments of the disclosure. The code library 200 contains pre-existing test cases that may be divided into code segments. The code segments may be analyzed and identified by topic modeling module 202. Each test case may include a plurality of code segments that are individually identifiable by the machine learning algorithm. In certain embodiments, at least one code segment that is commonly used may be marked as frequently-used within the code library by an identifier. The topic modeling module 202 may cluster words within code segments by topic 204 or cluster code segments by topic 206. In doing so, the topic modeling module 202 may discover topics that each test case within the code library contains, dividing the test cases into code segments, and associated the code segments in the code library with appropriate tagging or labeling based on the identified topic.

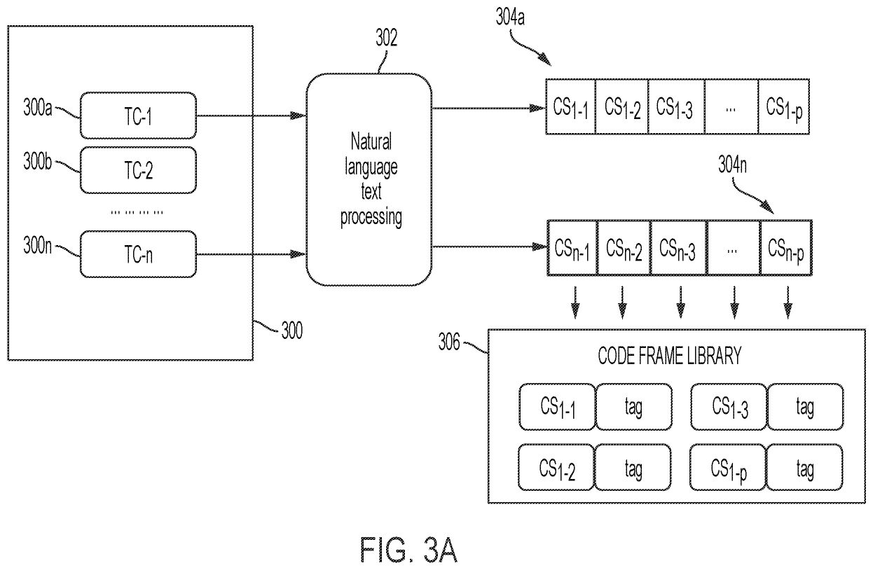

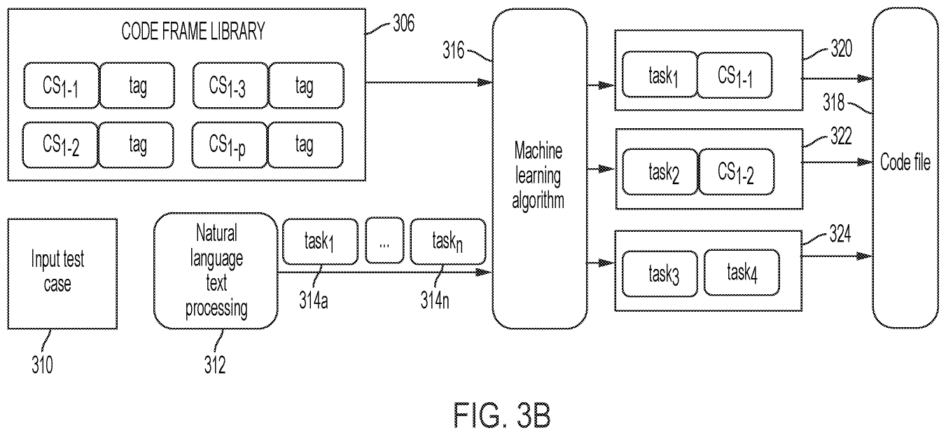

FIG. 3A is a block diagram illustrating generation of a code library from pre-existing test cases according to some embodiments of the disclosure. Code library 300 may include N pre-existing test cases 302 stored in a storage location, such as a network samba (SMB) folder. Each of the test cases 302 may have been previously coded by an automation test engineer for testing different systems or performing different tasks on a single system, or a combination of tests for a combination of systems. Test cases 300a-n may include code segments 304a-n. Different test cases may include different numbers of code segments. The test cases 300a-n may be processed by a national language text processing module 302 to determine code segments CS₁₋₁-CS_{1-P} through CS_{N-1}-CS_{N-P} within the test cases. The national language text processing module 302 may be, for example, a LDA. Using text vectorization, LDA transforms the code into a meaningful data which a machine learning module as described with reference to FIG. 3B can understand.

In some embodiments, the test cases 300a-n may be retrieved through a REST API. An API, or application programming interface, is a set of rules that define how applications or devices can connect to and communicate with each other. A REST API is an API that conforms to the design principles of the REST, or representational state transfer architectural style. REST APIs communicate via HTTP requests to perform standard database functions like creating, reading, updating, and deleting records (also known as CRUD) within a resource. For example, a REST API would use a GET request to retrieve a record, a POST request to create one, a PUT request to update a record, and a DELETE request to delete one. All HTTP methods can be used in API calls. A well-designed REST API is similar to a website running in a web browser with built-in HTTP functionality. The natural language text processing module 302 may also process the text of the code segments 304a-n to determine tags or other identifying information. The code library 306 may store the code segments CS_{1_1}-CS_{1-P} through CS_{N-1}-CS_{N-P} with associated tags. The code library 306 may be stored in, for example, a database or a storage location. When a new test case is developed, it may be added to the code library 300 and processed into code library 306 for future re-use.

FIG. 3B is a block diagram illustrating use of a code library in generating a code file corresponding to an input test case according to some embodiments of the disclosure. The code library 306 may be accessed by a machine learning module 316 executing a machine learning algorithm when processing an input test case 310 to identify potential code for re-use in coding the test case 310. The input test case 310 may be processed by a natural language text processing module 312 to determine a plurality of tasks 314a-n from the test case 310. Example tasks may include performing a dependency check, obtaining a generation or other information of the information handling system, obtaining processor model or other component information of the information handling system, ensuring if the OS IP is reachable before starting certain other tasks, verifying tool installation at a default or other predetermined path. The tasks 314a-n may have associated tags or other identifiers. The machine learning module 316 may receive the tasks 314a-n corresponding to the test case 310 and identify matching code segments from the code library 306.

The machine learning module 316 may output three categories of matches. A first category 320 of matches may be tasks with matching code segments that may be re-used without modification. A second category 322 of matches may be tasks with matching code segments that may need modification before re-use in a code file. An example of code in the second category 322 may be a code segment for verifying the presence of a PTU tool installation at a default path that may be modified to perform verifying the presence of a different tool at the default path. A third category 324 may be tasks with no matching code segments, such as corresponding code may need to be written by the automation test engineer. A code file 318 may be constructed from the indications in the three categories 320, 322, and/or 324, such as by modifying code segments in the second category 322 to match the tasks from the input test case 310, concatenating the modified code segments with code segments in the first category 320, and inserting a placeholder for code to be written corresponding to tasks in the third category 324.

In some embodiments, the machine learning module 316 may be a comparison tool that compares tags from the code library 306 with the tasks 314a-n to identify possible re-usable code segments from code library 306 without machine learning. The output of such a module may be an indication of matching code segments, which may be included in a report or a code file, as described with machine learning embodiments.

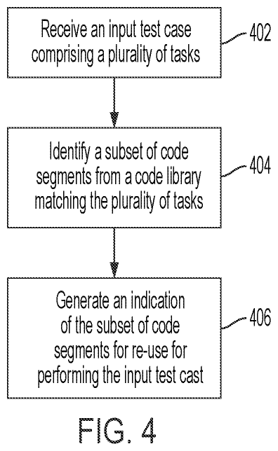

FIG. 4 is a flow chart illustrating a method for processing an input test case according to some embodiments of the disclosure. One embodiment of a method includes, at block 402, receiving an input test case comprising code for performing a plurality of tasks. At block 404, a subset of code segments from a code library are identified that match the plurality of tasks in the input test case. The matching may be performed using topic modeling of the pre-existing code segments in the code library and matching the topics with the tasks of the input test case. In some embodiments, the topic modeling may be performed using LDA. At block 406, an indication of the matching subset of code segments is generated, wherein the matching code segments may be re-used for forming code that performs the tasks of the input test case received at block 402.

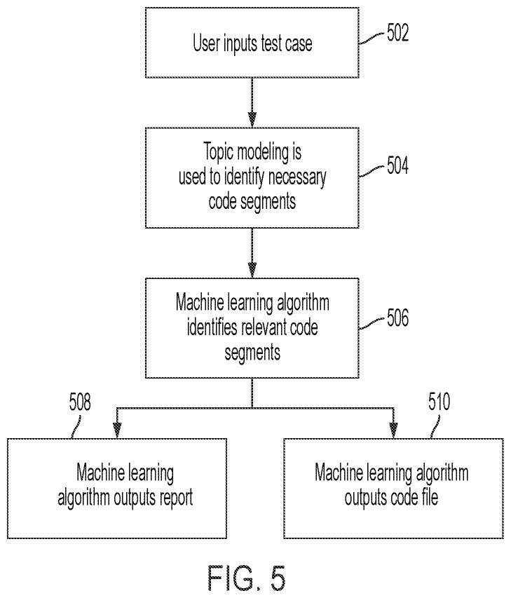

In some embodiments, the matching of FIG. 4 may be performed with a machine learning algorithm. FIG. 5 is a flow chart illustrating outputs based on processing of an input test case according to some embodiments of the disclosure. One embodiment of a method includes, at block 502, a user input a test case. At block 504, topic modeling is performed to categorize code segments of a code library. At block 506, a machine learning algorithm is used to identify relevant code segments from the code library. The machine learning algorithm may match tasks in the test case received at block 502 with topics identified in pre-existing test cases of block 504. In some embodiments, tasks of the input test case may similarly be processed by topic modeling, and the machine learning algorithm of block 506 compares tags of the code segments in the code library with tags of tasks in the input test case. The matching performed by block 506 may be used to generate output at blocks 508 and/or 510. At block 508, a report may be generated indicating the matches, the degree of match, a confidence in the match, and/or indications of which code segments may need to be modified for the input test case. At block 510, a code file may be generated based on the matches by concatenating code segments identified as matching at block 506.

Decision making in test automation can be time-consuming, especially when information is limited. Embodiments of an automation system described herein may provide a code file and also may provide the automation engineer with data analysis in a Testcase Analysis Report indicating, for example, percentages of different type of re-usable code. This reduces time that was previously invested in manual analysis of the test case requirements to conclude which portions of a new test case requires new development or the code that can be leveraged. The embodiments reduce the automation engineer's workload by generating the code file and/or a report that contains the categorized automation plan, thus saving the effort of manual analysis of testcase requirements.

These example embodiments describe and illustrate the use of an information handling system in processing input test cases, processing pre-existing test cases, matching tasks in input test cases to code segments in a code library of pre-existing test cases, and/or generating a report and/or code file based on the matched code segments. Example embodiments of an information handling system used to perform these operations is described below.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

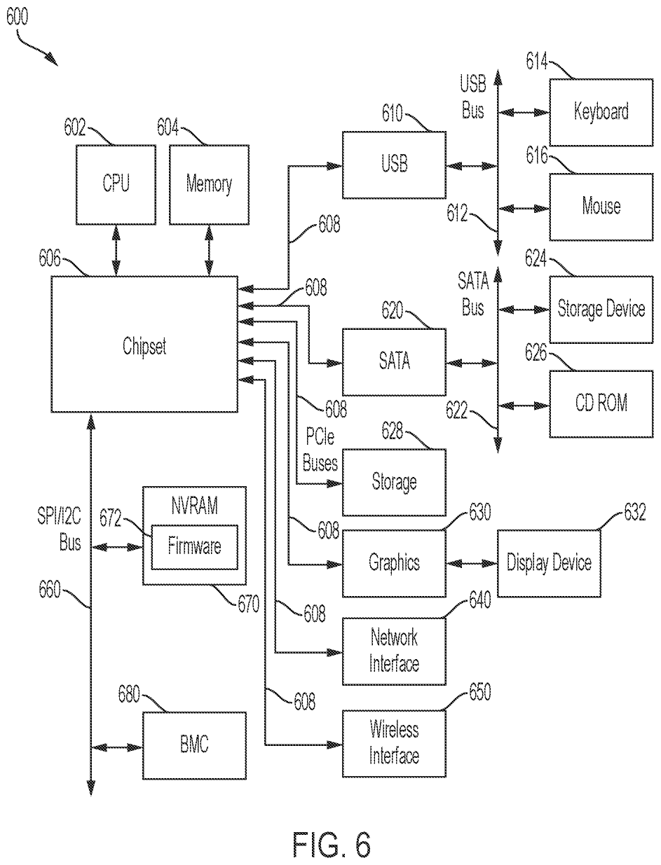

FIG. 6 illustrates an example information handling system 600. Information handling system 600 may include a processor 602 (e.g., a central processing unit (CPU)), a memory (e.g., a dynamic random-access memory (DRAM)) 604, and a chipset 606. In some embodiments, one or more of the processor 602, the memory 604, and the chipset 606 may be included on a motherboard (also referred to as a mainboard), which is a printed circuit board (PCB) with embedded conductors organized as transmission lines between the processor 602, the memory 604, the chipset 606, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 602, the memory 604, the chipset 606, and/or other components may be organized as a System on Chip (SoC).

The processor 602 may execute program code by accessing instructions loaded into memory 604 from a storage device, executing the instructions to operate on data also loaded into memory 604 from a storage device, and generate output data that is stored back into memory 604 or sent to another component. The processor 602 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 602 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 606 may facilitate the transfer of data between the processor 602, the memory 604, and other components. In some embodiments, chipset 606 may include two or more integrated circuits (ICs), such as a northbridge controller coupled to the processor 602, the memory 604, and a southbridge controller, with the southbridge controller coupled to the other components such as USB 610, SATA 620, and PCIe buses 608. The chipset 606 may couple to other components through one or more PCIe buses 608.

Some components may be coupled to one bus line of the PCIe buses 608, whereas some components may be coupled to more than one bus line of the PCIe buses 608. One example component is a universal serial bus (USB) controller 610, which interfaces the chipset 606 to a USB bus 612. A USB bus 612 may couple input/output components such as a keyboard 614 and a mouse 616, but also other components such as USB flash drives, or another information handling system. Another example component is a SATA bus controller 620, which couples the chipset 606 to a SATA bus 622. The SATA bus 622 may facilitate efficient transfer of data between the chipset 606 and components coupled to the chipset 606 and a storage device 624 (e.g., a hard disk drive (HDD) or solid-state disk drive (SDD)) and/or a compact disc read-only memory (CD-ROM) 626. The PCIe bus 608 may also couple the chipset 606 directly to a storage device 628 (e.g., a solid-state disk drive (SDD)). A further example of an example component is a graphics device 630 (e.g., a graphics processing unit (GPU)) for generating output to a display device 632, a network interface controller (NIC) 640, and/or a wireless interface 650 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 606 may also be coupled to a serial peripheral interface (SPI) and/or Inter-Integrated Circuit (I2C) bus 660, which couples the chipset 606 to system management components. For example, a non-volatile random-access memory (NVRAM) 670 for storing firmware 672 may be coupled to the bus 660. As another example, a controller, such as a baseboard management controller (BMC) 680, may be coupled to the chipset 606 through the bus 660. BMC 680 may be referred to as a service processor or embedded controller (EC). Capabilities and functions provided by BMC 680 may vary considerably based on the type of information handling system. For example, the term baseboard management system may be used to describe an embedded processor included at a server, while an embedded controller may be found in a consumer-level device. As disclosed herein, BMC 680 represents a processing device different from processor 602, which provides various management functions for information handling system 600. For example, an embedded controller may be responsible for power management, cooling management, and the like. An embedded controller included at a data storage system may be referred to as a storage enclosure processor or a chassis processor.

System 600 may include additional processors that are configured to provide localized or specific control functions, such as a battery management controller. Bus 660 can include one or more busses, including a Serial Peripheral Interface (SPI) bus, an Inter-Integrated Circuit (I2C) bus, a system management bus (SMBUS), a power management bus (PMBUS), or the like. BMC 680 may be configured to provide out-of-band access to devices at information handling system 600. Out-of-band access in the context of the bus 160 may refer to operations performed prior to execution of firmware 672 by processor 602 to initialize operation of system 600.

Firmware 672 may include instructions executable by processor 602 to initialize and test the hardware components of system 600. For example, the instructions may cause the processor 602 to execute a power-on self-test (POST). The instructions may further cause the processor 602 to load a boot loader or an operating system (OS) from a mass storage device. Firmware 672 additionally may provide an abstraction layer for the hardware, such as a consistent way for application programs and operating systems to interact with the keyboard, display, and other input/output devices. When power is first applied to information handling system 600, the system may begin a sequence of initialization procedures, such as a boot procedure or a secure boot procedure. During the initialization sequence, also referred to as a boot sequence, components of system 600 may be configured and enabled for operation and device drivers may be installed. Device drivers may provide an interface through which other components of the system 600 can communicate with a corresponding device. The firmware 672 may include a basic input-output system (BIOS) and/or include a unified extensible firmware interface (UEFI). Firmware 672 may also include one or more firmware modules of the information handling system. Additionally, configuration settings for the firmware 672 and firmware of the information handling system 600 may be stored in the NVRAM 670. NVRAM 670 may, for example, be a non-volatile firmware memory of the information handling system 600 and may store a firmware memory map namespace of the information handling system. NVRAM 670 may further store one or more container-specific firmware memory map namespaces for one or more containers concurrently executed by the information handling system.

Information handling system 600 may include additional components and additional busses, not shown for clarity. For example, system 600 may include multiple processor cores (either within processor 602 or separately coupled to the chipset 606 or through the PCIe buses 608), audio devices (such as may be coupled to the chipset 606 through one of the PCIe busses 608), or the like. While a particular arrangement of bus technologies and interconnections is illustrated for the purpose of example, one of skill will appreciate that the techniques disclosed herein are applicable to other system architectures. System 600 may include multiple processors and/or redundant bus controllers. In some embodiments, one or more components may be integrated together in an integrated circuit (IC), which is circuitry built on a common substrate. For example, portions of chipset 606 can be integrated within processor 602. Additional components of information handling system 600 may include one or more storage devices that may store machine-executable code, one or more communications ports for communicating with external devices, and various input and output (I/O) devices, such as a keyboard, a mouse, and a video display.

In some embodiments, processor 602 may include multiple processors, such as multiple processing cores for parallel processing by the information handling system 600. For example, the information handling system 600 may include a server comprising multiple processors for parallel processing. In some embodiments, the information handling system 600 may support virtual machine (VM) operation, with multiple virtualized instances of one or more operating systems executed in parallel by the information handling system 600. For example, resources, such as processors or processing cores of the information handling system may be assigned to multiple containerized instances of one or more operating systems of the information handling system 600 executed in parallel. A container may, for example, be a virtual machine executed by the information handling system 600 for execution of an instance of an operating system by the information handling system 600. Thus, for example, multiple users may remotely connect to the information handling system 600, such as in a cloud computing configuration, to utilize resources of the information handling system 600, such as memory, processors, and other hardware, firmware, and software capabilities of the information handling system 600. Parallel execution of multiple containers by the information handling system 600 may allow the information handling system 600 to execute tasks for multiple users in parallel secure virtual environments.

The schematic flow chart diagram of FIG. 3A and FIG. 3B or flow chart diagrams of FIG. 4 and FIG. 5 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Machine learning models, as described herein, may include logistic regression techniques, linear discriminant analysis, linear regression analysis, artificial neural networks, machine learning classifier algorithms, or classification/regression trees in some embodiments. In various other embodiments, machine learning systems may employ Naive Bayes predictive modeling analysis of several varieties, learning vector quantization artificial neural network algorithms, or implementation of boosting algorithms such as Adaboost or stochastic gradient boosting systems for iteratively updating weighting to train a machine learning classifier to determine a relationship between an influencing attribute, such as a tag on a code segment in a pre-existing test case, and a task in an input test case for which a code file is to be generated, and/or a degree to which such an influencing attribute affects the outcome of such a system or output code file.

The operations described above as performed by a controller may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuitry may be configured as a general purpose processor capable of executing instructions contained in software and/or firmware.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description as executing operations related to the processing of test cases, aspects of the invention may be executed on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
receiving, by an information handling system, a test case comprising a plurality of tasks;
identifying, by the information handling system by inputting the test case into a machine learning algorithm, a subset of code segments from code segments of at least one pre-existing test case in a code library matching at least one task of the plurality of tasks in the test case; and
generating, by the information handling system, an indication of the subset of code segments for re-use from the at least one pre-existing test case for the test case.

2. The method of claim 1, further comprising generating a report comprising a first indication of a first portion of the plurality of tasks not matching any of the at least one pre-existing test case, a second indicator of a second portion of the plurality of tasks partially matching a first portion of the plurality of tasks, and a third indicator of a third portion of the plurality of tasks matching a second portion of the plurality of tasks.

3. The method of claim 1, further comprising determining at least one tag corresponding to each of the code segments, wherein identifying the subset of code segments matching at least one task is based on comparing the at least one tag of each of the code segments with at least one task.

4. The method of claim 3, wherein determining the at least one tag corresponding to each of the code segments comprises analyzing the code segments using a latent Dirichlet allocation (LDA) algorithm.

5. The method of claim 3, wherein determining the at least one tag corresponding to each of the code segments comprises analyzing the code segments using topic modeling.

6. The method of claim 1, further comprising determining a code file for performing the test case, the code file comprising: a first portion corresponding to a first subset of tasks of the plurality of tasks for completion by a user; and a second portion corresponding to a second subset of tasks of the plurality of tasks comprising at least one code segment of the subset of code segments from the code library.

7. The method of claim 6, further comprising determining at least one modified code segment based on at least one code segment of the subset of code segments for re-use for performing a corresponding task of the plurality of tasks of the test case, wherein the code file further comprises a third portion corresponding to a second subset of tasks of the plurality of tasks comprising the at least one modified code segment.

8. An information handling system, comprising:
a memory;
a processor coupled to the memory, wherein the processor is configured to perform steps comprising:
receiving, by an information handling system, a test case comprising a plurality of tasks;
identifying, by the information handling system by inputting the test case into a machine learning algorithm, a subset of code segments from code segments of at least one pre-existing test case in a code library matching at least one task of the plurality of tasks in the test case; and
generating, by the information handling system, an indication of the subset of code segments for re-use from the at least one pre-existing test case for the test case.

9. The information handling system of claim 8, wherein the processor is further configured to perform operations including generating a report comprising a first indicator of a first portion of the plurality of tasks not matching any of the at least one pre-existing test case, a second indicator of a second portion of the plurality of tasks partially matching a first portion of the plurality of tasks, and a third indicator of a third portion of the plurality of tasks matching a second portion of the plurality of tasks.

10. The information handling system of claim 8, wherein the processor is further configured to perform operations including determining at least one tag corresponding to each of the code segments, wherein identifying the subset of code segments matching at least one task is based on comparing the at least one tag of each of the code segments with at least one task.

11. The information handling system of claim 10, wherein determining the at least one tag comprises analyzing the code segments using a latent Dirichlet allocation algorithm.

12. The information handling system of claim 8, wherein the processor is further configured to perform operations including determining a code file for performing the test case, the code file comprising: a first portion corresponding to a first subset of tasks of the plurality of tasks for completion by a user; and a second portion corresponding to a second subset of tasks of the plurality of tasks comprising at least one code segment of the subset of code segments from the code library.

13. The information handling system of claim 12, wherein the processor is further configured to perform operations including determining at least one modified code segment based on at least one code segment of the subset of code segments for re-use for performing a corresponding task of the plurality of tasks of the test case, wherein the code file further comprises a third portion corresponding to a second subset of tasks of the plurality of tasks comprising the at least one modified code segment.

14. A computer program product, comprising:
a non-transitory computer readable medium comprising code for performing steps comprising:
receiving, by an information handling system, a test case comprising a plurality of tasks;
identifying, by the information handling system by inputting the test case into a machine learning algorithm, a subset of code segments from code segments of at least one pre-existing test case in a code library matching at least one task of the plurality of tasks in the test case; and
generating, by the information handling system, an indication of the subset of code segments for re-use from the at least one pre-existing test case for the test case.

15. The computer program product of claim 14, wherein the medium further comprises code for performing operations including generating a report comprising a first indicator of a first portion of the plurality of tasks not matching any of the at least one pre-existing test case, a second indicator of a second portion of the plurality of tasks partially matching a first portion of the plurality of tasks, and a third indicator of a third portion of the plurality of tasks matching a second portion of the plurality of tasks.

16. The computer program product of claim 14, wherein the medium further comprises code for performing operations including determining at least one tag corresponding to each of the code segments, wherein identifying the subset of code segments matching at least one task is based on comparing the at least one tag of each of the code segments with at least one task.

17. The computer program product of claim 16, wherein determining the at least one tag comprises analyzing the code segments using a latent Dirichlet allocation algorithm.

18. The computer program product of claim 16, wherein determining the at least one tag corresponding to each of the code segments comprises analyzing the code segments using topic modeling.

19. The computer program product of claim 14, wherein the medium further comprises code for performing operations including determining a code file for performing the test case, the code file comprising: a first portion corresponding to a first subset of tasks of the plurality of tasks for completion by a user; and a second portion corresponding to a second subset of tasks of the plurality of tasks comprising at least one code segment of the subset of code segments from the code library.

20. The computer program product of claim 19, wherein the medium further comprises code for performing operations including determining at least one modified code segment based on at least one code segment of the subset of code segments for re-use for performing a corresponding task of the plurality of tasks of the test case, wherein the code file further comprises a third portion corresponding to a second subset of tasks of the plurality of tasks comprising the at least one modified code segment.
